(19) United States
(12) Patent Application Publication
(10) Pub. No.: US 2026/0293817 A1
(43) Pub. Date: Oct. 1, 2026

(54) MICROGREENS GROWING AND HARVESTING SYSTEM

(71) Applicant: Always Spring LLC, Little Elm, TX (US)

(72) Inventor: James Seeger, Little Elm, TX (US)

(73) Assignee: Always Spring LLC, Little Elm, TX (US)

(21) Appl. No.: 19/314,379

(22) Filed: Aug. 29, 2025

Related U.S. Application Data
(60) Provisional application No. 63/781,448, filed on Apr. 1, 2025.

(51) Int. Cl. A01G 13/37; A01D 45/00

(52) U.S. Cl. CPC A01G 9/143; A01G 9/0293; A01G 9/0299

(57) ABSTRACT

A modular microgreen growing and harvesting apparatus, system (10), and method (100) includes a pre-harvest mat (12) and a harvester (30). The pre-harvest mat (12) features a lattice (16) structure that supports seed distribution, germination, and vertical plant growth while allowing air and water circulation. Riser clips (18) elevate the pre-harvest mat (12). The harvester (30) includes a base (32), side guards (34), a stationary back stop (36), and a front recess (38) for ergonomic tray insertion/removal. A rack-and-pinion mechanism (42) provides precise height control of the side guards (34). Elevation setting and correlation indicators (24, 54) on the riser clips (18) and stanchions (39) enable alignment for consistent use across different types of microgreens and setups.

### CROSS-REFERENCE TO RELATED APPLICATIONS

This application claims priority under 35 U.S.C. § 119 to provisional application Ser. No. 63/781,448 filed Apr. 1, 2025, which is incorporated by reference in its entirety.

### BACKGROUND OF THE DISCLOSURE

### Field of the Disclosure

This disclosure relates to systems, methods and apparatuses for growing and harvesting microgreens, particularly a reusable, modular system that facilitates both consistent plant growth and efficient harvesting without damaging the product or requiring extensive handling.

### Description of Related Art

Traditional microgreen cultivation and harvesting involve planting in soil or grow mats and manually cutting mature plants. These methods can lead to inconsistent growth, product loss, contamination, and require labor-intensive handling. There is a need for an integrated system that supports both consistent microgreen growth and efficient, ergonomic harvesting with minimal waste and mess.

### SUMMARY OF THE DISCLOSURE

Therefore, it is a primary object, feature, or advantage of the present disclosure to improve over the state of the art.

It is an object, feature, or advantage of the present disclosure to provide a microgreen growing and harvesting system that improves efficiency, promotes uniform plant growth, and reduces product loss.

It is a further object, feature, or advantage of the present disclosure to provide a pre-harvest mat that stabilizes plant growth and facilitates uniform spacing and upward development of microgreens.

It is still a further object, feature, or advantage of the present disclosure to provide an adjustable harvesting device with integrated guides and elevation control.

It is another object, feature, or advantage of the present disclosure to provide a lockable rack-and-pinion mechanism for precise adjustment of harvesting guides.

It is a yet another object, feature, or advantage of the present disclosure to provide a numbered alignment system between riser clips and riser brackets to ensure consistent height positioning during both growing and harvesting phases.

It is at least one other further object, feature, or advantage of the present disclosure to support modularity, repeatable setup, and reuse in microgreen farming tools.

The disclosure includes, in at least one exemplary aspect, a microgreen grower and harvester apparatus (10) having a pre-harvest mat (12) with a frame (14) housing a lattice (16) with grid openings, a set of riser clips (18), and a harvester (30) with a base (32), a pair of side guards (34), a back stop (36), a front recess (38), and riser brackets (40) operably connected to the side guards (34) and the base (32). The riser brackets (40) include a rack-and-pinion mechanism (42) for vertical adjustment of the side guards (34) relative to the base (32) and the riser clips (18) attached to the pre-harvest mat (12) during growing, enabling precise control over the harvesting height.

Additionally, the disclosure provides, in at least another exemplary aspect, a microgreen planting and harvesting system (10) that includes a pre-harvest mat (12) with a lattice (16) configured to allow plant growth through grid openings, a growing tray (26) for growing plants, a set of riser clips (18) for securing the pre-harvest mat (12) to the growing tray (26) at a desired elevation setting during growing, and a harvester (30) with a base (32), side guards (34), and riser brackets (40). This system supports cutting of the grown plants at a correlated elevation setting between the riser clips (18) and side guards (34), retaining harvested plants within the harvester (30) for ease in gathering and packaging.

The disclosure further describes, in at least one other exemplary aspect, a method of growing and harvesting microgreens (100) involving securing a pre-harvest mat (12) to a growing tray (26) with riser clips (18) in Step 102, growing microgreens in the tray (26) through the pre-harvest mat (12) in Step 106, placing the tray (26) into a harvester (30) after removing riser clips (18) in Step 108, and cutting the microgreens across the top of the pre-harvest mat (12) and underneath a bottom side of side guards (34) of the harvester (30) in Step 114. This method (100) supports cutting and contains the cut microgreens within the harvester (30) using pre-harvest mat (12), side guards (34), and back stop (36) to facilitate an efficient and mess-free harvest and packaging.

### BRIEF DESCRIPTION OF THE DRAWINGS

FIG. 1 is a perspective view of a pre-harvest mat (12) positioned atop a growing tray (26) in accordance with an exemplary microgreen growing and harvesting system (10) of the present disclosure.

FIG. 2 is a perspective view of the pre-harvest mat (12), showing the frame (14) and lattice (16) with one of several contemplated lattice configurations.

FIG. 3 is a detailed view of a lattice (16) structure and showing a single opening of the pre-harvest mat (12) taken along line 3-3 in FIG. 2.

FIG. 4 is a perspective view of a riser clip (18) configured for use with the pre-harvest mat (12), including the tray bracket (20), adjustable pre-harvest mat brackets (22), and elevation setting and correlation indicators (24).

FIG. 5 is a perspective view illustrating a tray bracket (20) of the riser clip (18) secured to a rim (28) of growing tray (26) and an adjustable pre-harvest mat bracket (22) of riser clip (18) secured to a frame (14) of pre-harvest mat (12) at one of elevation setting and correlation indicators (24).

FIG. 6 is a perspective view of a harvester (30) base frame (32) configured to receive the growing tray (26) and pre-harvest mat (12) in accordance with an exemplary microgreen growing and harvesting system (10) of the present disclosure.

FIG. 7 is another perspective view of the harvester (30), including the locking mechanism (44), left rack segment (46), right rack segment (48), left riser knob (50), and right riser knob (52).

FIG. 8 is a perspective view of a microgreen growing and harvesting system (10) with a pre-harvest mat (12) positioned atop a growing tray (26) containing grown microgreens and positioned in preparation for being harvested.

FIG. 9 is a perspective view showing elevation setting and correlation indicators (24, 54) between riser clips (18) and riser brackets (40).

FIG. 10 is a perspective view illustrating various microgreen growing and harvesting components in accordance with an exemplary aspect.

FIG. 11 is a flow diagram illustrating a method (100) for the microgreen growing and harvesting system (10) in accordance with an exemplary aspect of the present disclosure.

### DETAILED DESCRIPTION OF THE DISCLOSURE

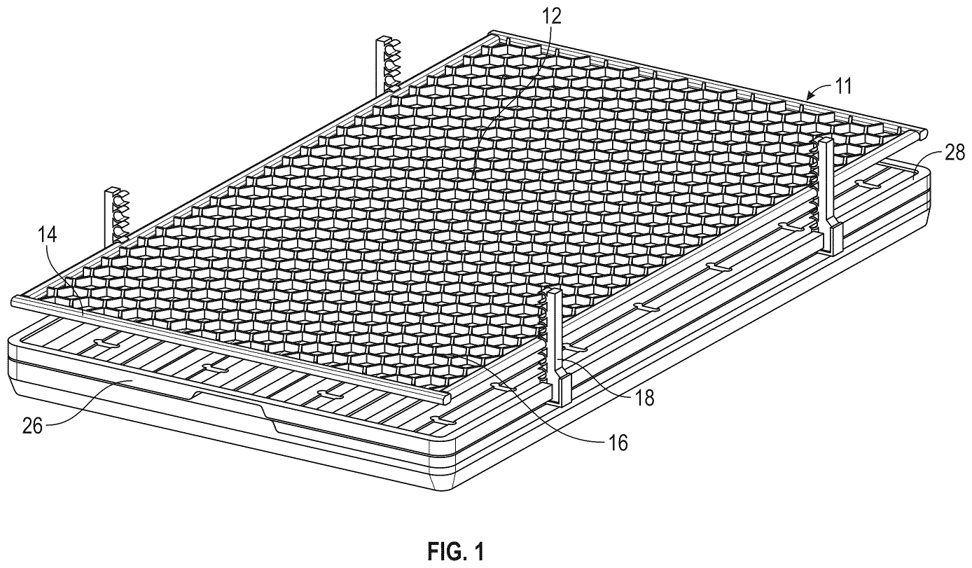

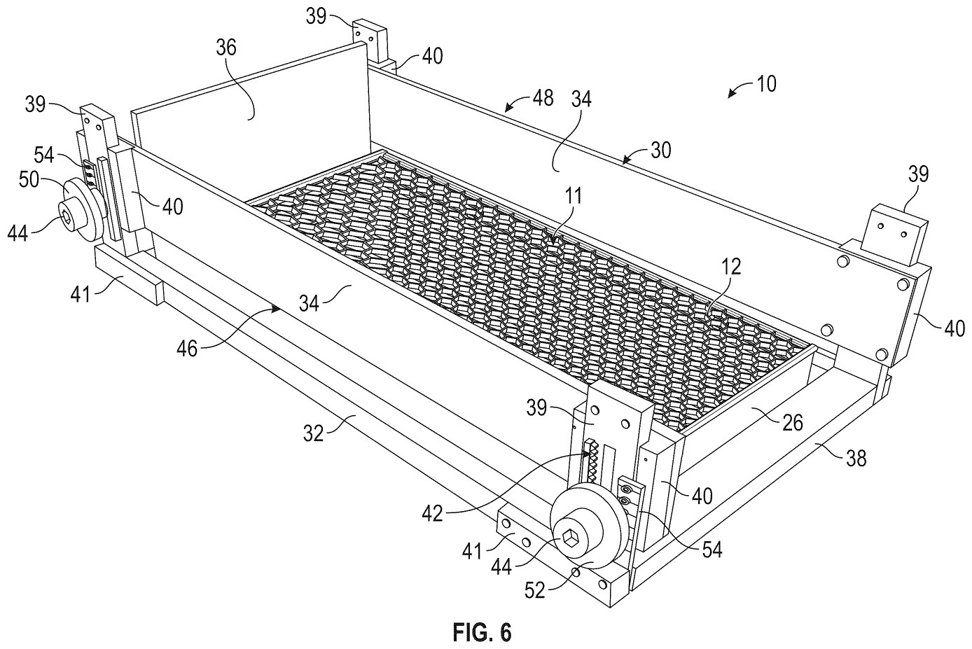

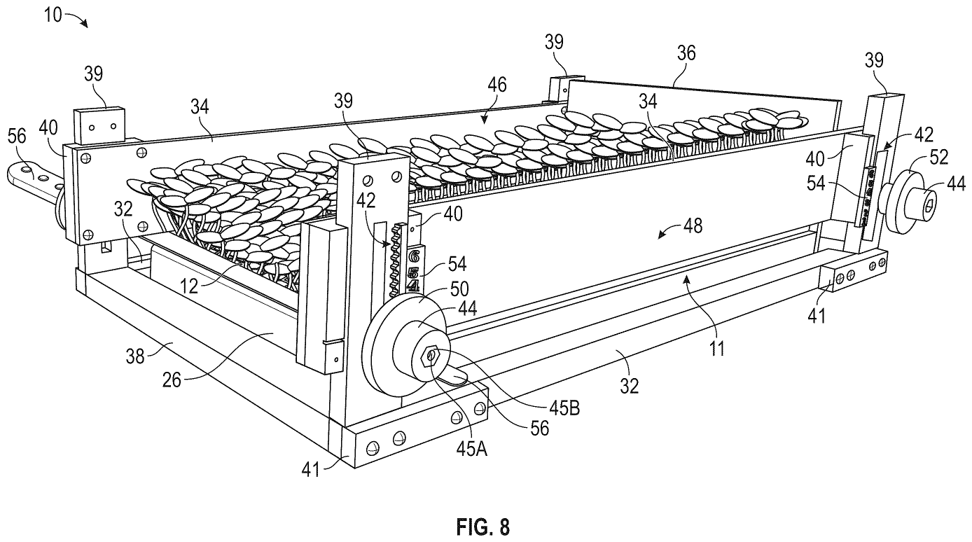

The disclosure provides a modular microgreen growing and harvesting system (10) (see, e.g., FIG. 8), corresponding apparatuses and methods that include two main components: a pre-harvest mat assembly (11) (see, e.g., FIG. 1) and a harvester (30) providing a harvester (30) (see, e.g., FIG. 6).

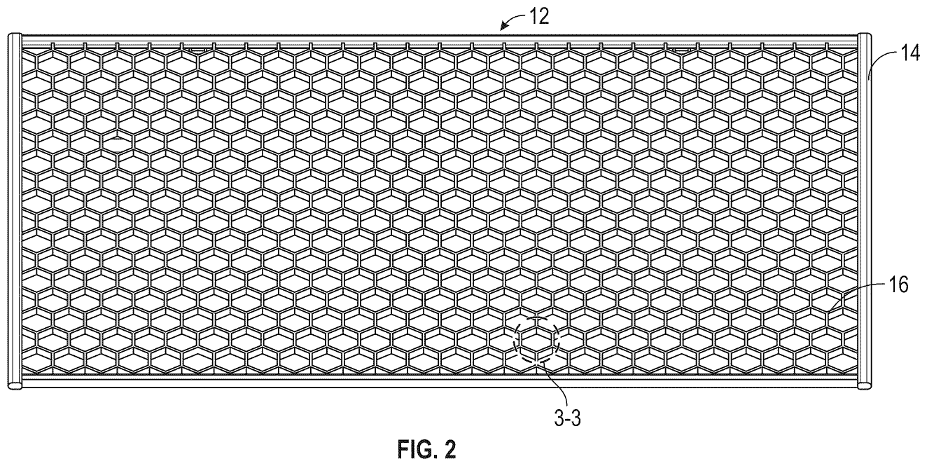

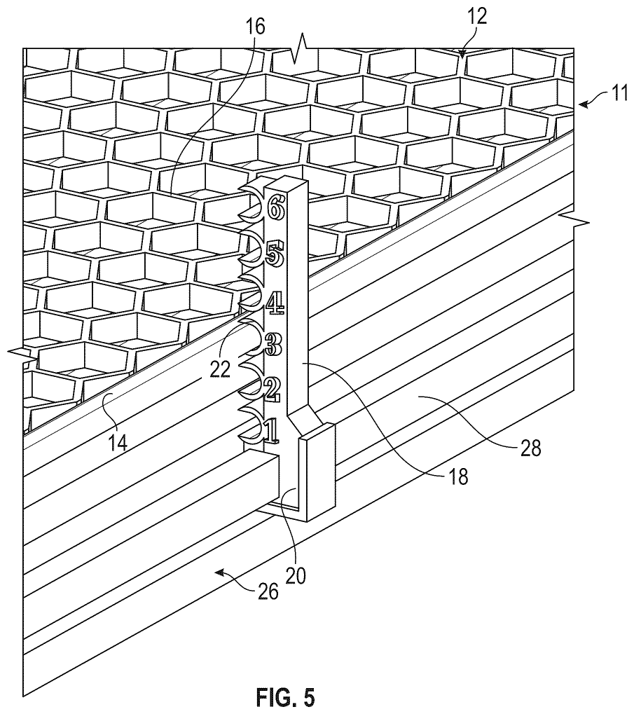

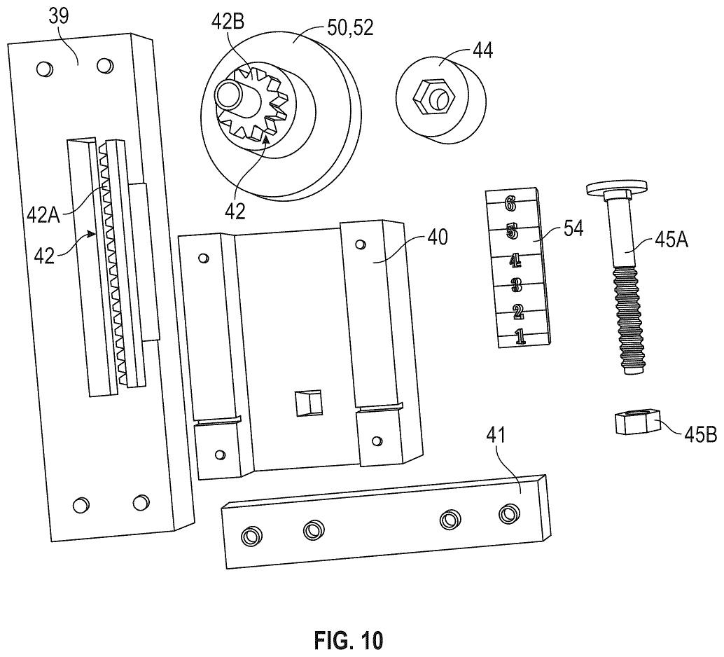

FIGS. 1-11 provide examples of a microgreen grower and harvester apparatus (30), a microgreen planting and harvesting system (10), and a method of growing and harvesting microgreens (100).

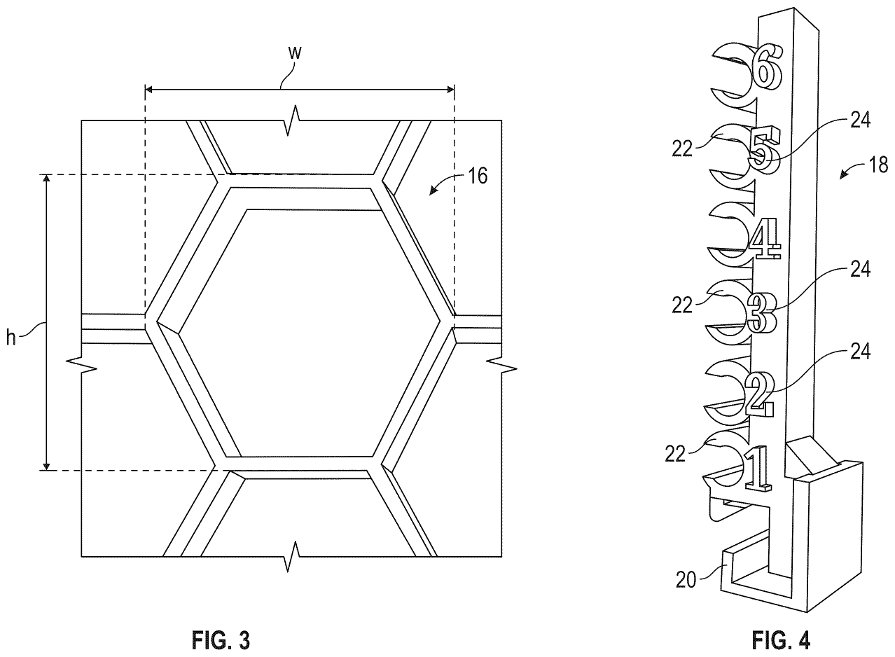

The pre-harvest mat assembly (11) of the microgreen growing and harvesting system (10) includes a reusable pre-harvest mat (12) constructed from durable materials such as polycarbonate, acrylic, polypropylene, polystyrene, ABS, nylon, biodegradable plastics, recycled plastics, or other suitable composites. In some aspects, the pre-harvest mat (12) may be made from flexible materials like silicone or rubber to allow for easier removal of grown microgreens, or it may incorporate antimicrobial coatings to reduce contamination risks. The pre-harvest mat (12) features a frame (14) and a uniform lattice (16) pattern, preferably hexagonal but alternatively circular, square, or irregular in shape to accommodate different microgreen varieties or growth patterns. Each grid opening in the lattice (16) is sized to approximately 0.75 inches to guide seed placement, support germination, and allow microgreens to grow upright through the structure, improving light exposure, airflow, and consistent vertical development during the growing cycle. In alternative configurations, the grid openings may range from 0.5 to 1.5 inches in width (w) and (h), as shown for example in FIG. 3, to suit various microgreen species, and the lattice (16) can include adjustable or removable sections to modify the grid pattern as needed. The frame (14) can also include reinforced edges or mounting points for additional stability or attachment mechanisms, such as hooks or clips, to secure the mat to other components during growth or transport.

Also, part of the pre-harvest mat assembly (11) are riser clips (18), which attach to the pre-harvest mat (12) and secure it in a raised and microgreen type appropriate position above a growing tray (26). The riser clips (18) include a tray bracket (20), a series of vertically successive adjustable pre-harvest mat brackets (22), and elevation setting and correlation indicators (24) corresponding with each pre-harvest mat bracket (22). The tray bracket (20) can be designed with a snap-fit, screw-on, or magnetic attachment mechanism to securely fasten to the growing tray (26), and in some embodiments, it may include a pivot or hinge to allow for angular adjustments of the pre-harvest mat (12) relative to the tray (26) or rim (28). The adjustable pre-harvest mat brackets (22) may feature a ratchet system, spring-loaded mechanism, or telescopic design to allow for finer height adjustments, accommodating different growth stages or tray depths. The elevation setting and correlation indicators (24) on the riser clips (18) are designed for alignment purposes, typically as numbered or color-coded markings, but in alternative embodiments, they may include digital displays or RFID tags for automated height tracking in smart farming systems. These clips (18) allow airflow and drainage beneath the pre-harvest mat (12), position the pre-harvest mat (12) at a height correlated with the type of microgreen being grown, and prevent the mat from being displaced by microgreen growth. The clips (18) are designed for reuse and may be formed from rigid or moldable materials, such as metal alloys, reinforced plastics, or biodegradable composites, depending on the desired durability and environmental impact.

The growing tray (26) is configured to hold the growing medium and microgreen seeds, and root mass of grown microgreens, and features a rim (28) for structural integrity and to facilitate attachment of the riser clips (18). In some embodiments, the growing tray (26) may include drainage holes, irrigation channels, or a modular design with stackable sections to accommodate different growing depths or to integrate with automated watering systems. The tray (26) may also be equipped with sensors to monitor moisture, temperature, or nutrient levels, enhancing precision in microgreen cultivation.

The harvester (30) includes a base (32) designed to receive the growing tray (26) and pre-harvest mat assembly (11) during harvest. The base (32) can be formed of multiple interconnected base members and is formed as a rectangular frame that incorporates a stationary back stop (36) to prevent rearward tray movement and provide a backstop for grown microgreens during harvesting. The base (32) can include a front recess (38) to allow easy manual access for inserting the pre-harvest mat assembly (11) pre-harvest and removing the pre-harvest mat assembly (11) post-harvest. In alternate aspects, the front recess (38) may be replaced with a hinged or removable front wall akin to back stop (36), or it may include a sliding mechanism to facilitate pre-harvest mat assembly (11) insertion and removal in automated systems. The base (32) may also be constructed with adjustable dimensions, such as expanding/contracting base members, to accommodate different growing tray (26) sizes, or it may feature a modular design with detachable sections for scalability in commercial operations.

Opposing side guards (34) are mounted on either side of the harvester base (32) and function to retain microgreens in an upright orientation and contained during harvesting, such as by cutting with a harvesting knife (56). The side guards (34) may be fixed in place, spring-loaded, or hinge-mounted to allow lateral access during harvesting. In some embodiments, the side guards (34) may be transparent or include perforations to improve visibility and airflow, or they may be equipped with sensors to detect the height of the microgreens for automated cutting adjustments. The side guards (34) may also be adjustable in width and height to accommodate different growing tray (26) sizes or microgreen plant growth heights and densities.

Each corner of the harvester (30) assembly includes a vertically adjustable riser bracket (40) that supports opposing ends of the side guards (34) of the harvester (30), such as by removably securing opposing ends of side guards (34) to back sides of opposing riser brackets (40) on the left rack segment (46) and right rack segment (48). Opposing ends of side guards (34) can be removably secured to opposing riser brackets (40) with a snap-fit, screw-on, or magnetic attachment mechanism. The riser brackets (40) can be u-shaped to fit around three sides of and slide vertically on corresponding stanchions (39) which can be attached by a corresponding stanchion bracket (41) to a corresponding base member of base (32). Each stanchion (39) includes an integrated rack (42A) of a rack-and-pinion mechanism (42) for precise height control of side guards (34), such as, by correlation with elevation setting and correlation indicators (54) also integrated with or removably attached to stanchion (39). In at least one aspect, integrated rack (42A) is vertically oriented in stanchion (39) for vertical movement of a corresponding pinion (42B) of rack-and-pinion mechanism (42). Each pinion (42B) is integrated in a corresponding riser knob (50, 52), and each riser knob (50, 52) is operably secured to a corresponding locking mechanism (44) together which are operably secured to the corresponding riser bracket (40) via a locking bolt (45A) and a corresponding locking nut (45B). Alternatively, riser knob (50, 52) with integrated pinion (42B) and corresponding locking mechanism (44) can also be operably secured to the corresponding riser bracket (40) using a snap-fit, screw-on, or magnetic attachment mechanism for adjusting the height of side guards (34). In alternate aspects, the rack-and-pinion mechanism (42) can be implemented using telescopic risers, threaded rods, pneumatic cylinders, or magnetic lifts, depending on the desired precision and automation level. Microgreen growing and harvesting system (10) is configured with a left rack segment (46) and a right rack segment (48); each rack segment (46, 48) includes opposing rack-and-pinion mechanisms (42) operating side guards (34) up and down in a correlated manner by matching movement of each corresponding rack-and-pinion mechanism (42) with corresponding elevation setting and correlation indicators (54). Similarly, movement up and down of rack segments (46, 48) is also done in a correlated manner by matching movement of each corresponding rack-and-pinion mechanism (42) with corresponding elevation setting and correlation indicators (54).

In one aspect, opposing left rack segment (46) and right rack segment (48) include corresponding left riser knob (50) and right riser knob (52). The locking mechanisms (44) for each may be a clamp, friction detent, ratchet, or magnetic lock, and in some embodiments, it may include a quick-release feature for rapid adjustments. In another aspect, locking mechanism (44) can be rotated separate from corresponding knob (50, 52) to pinch stanchion (39) between knobs (50, 52) and corresponding riser bracket (40) to lock movement of pinion (42B) relative to rack (42A) as locking nut (45B) tightens down on locking bolt (45A), which can be accomplished, for example, by preventing rotation of knob (50, 52) while turning locking mechanism (44) clockwise. Conversely, unlocking locking mechanism (44), to adjust the height of side guards (34), can be accomplished, for example, by preventing rotation of knob (50, 52) while turning locking mechanism (44) counterclockwise.

The left rack segment (46) and right rack segment (48) may be made from durable materials like stainless steel or reinforced plastic, and they may include wear-resistant coatings to ensure longevity. The left rack segment (46) includes a corresponding left riser knob (50) and a corresponding right riser knob (52). Similarly, the right segment (48) includes a corresponding left riser knob (50) and a corresponding right riser knob (52). Riser knobs (50, 52) of left rack segment (46) and riser knobs (50, 52) of right rack segment (48) are turned in opposite directions-clockwise and counterclockwise, respectively-to achieve coordinated elevation of verified, for example, by adjusting elevation to the same elevation setting and correlation indicators (54). In alternative configurations, the knobs (50, 52) may be replaced with motorized actuators or touch-sensitive controls for automated height adjustments in smart harvesting systems.

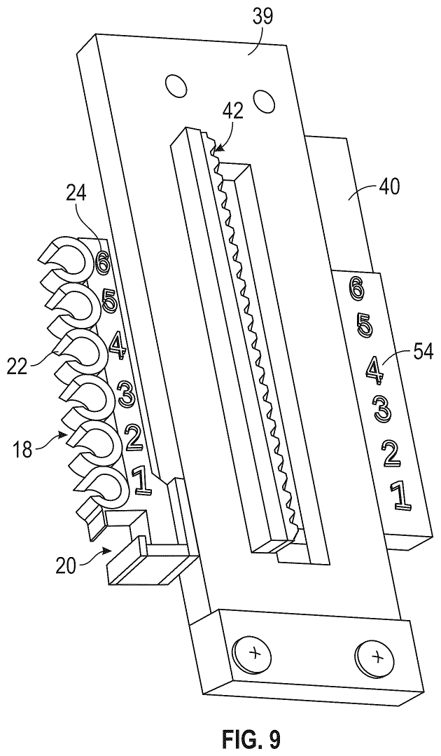

Each stanchion (39) and riser clip (18) include elevation setting and correlation indicators (24, 54) as shown, for example, in FIG. 9 to ensure proper height alignment across the system during both growing and harvesting. These indicators may be numerical, color-coded, or tactile (e.g., braille) to accommodate different user needs, and in advanced embodiments, they may integrate with a digital interface for real-time monitoring and adjustment. This allows users to easily match the elevation of the pre-harvest mat (12) with the position of the side guards (34) or adapt to different crop stages, ensuring optimal cutting height and minimizing damage to the microgreens.

The entire microgreen growing and harvesting system (10) is designed to be modular, reusable, and ergonomic. It promotes consistent growth, efficient harvesting, minimal mess, and supports repeatable tray setups across different grow environments. The system is suitable for both small-scale and commercial microgreen operations and may be adapted for different tray sizes, materials, growing media, and harvesting preferences. In some embodiments, the system (10) may be integrated with automated components, such as robotic arms for cutting, conveyor belts for tray transport, or IoT-enabled sensors for environmental monitoring, to enhance scalability and efficiency in large-scale operations. Additionally, the system (10) may be configured for use in vertical farming setups, hydroponic systems, or controlled environment agriculture (CEA) facilities, with components designed to withstand varying humidity, temperature, and lighting conditions.

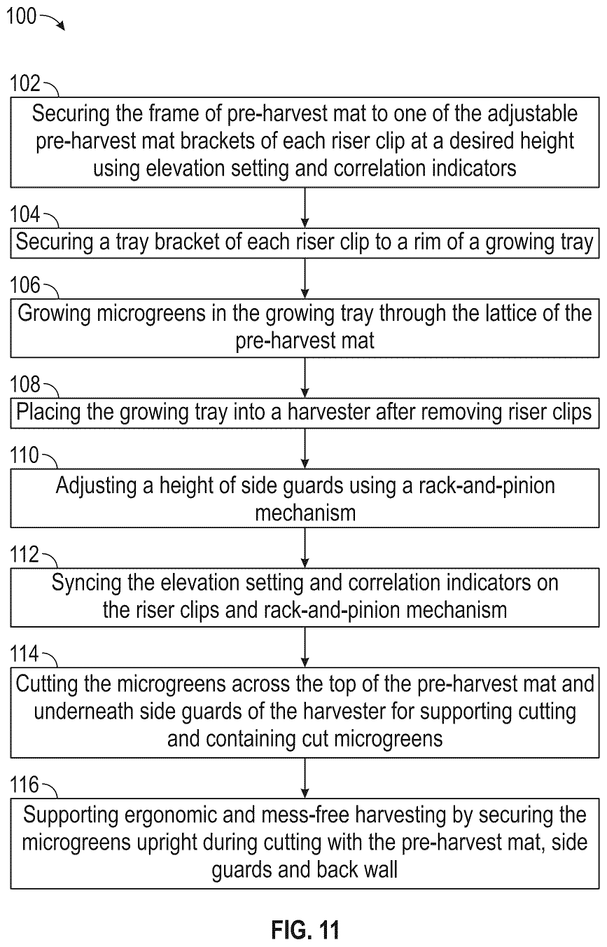

The disclosure includes an exemplary microgreen growing and harvesting method (100). Aspects of the microgreen growing and harvesting method (100) are illustrated in FIG. 11, while other aspects are further elaborated in the other figures. The microgreen growing and harvesting method (100) begins by placing seeds for growing microgreens in the growing tray (26) before securing the pre-harvest mat (12) to the growing tray (26) using the set of riser clips (18). The tray bracket (20) of each riser clip (18) is attached to the rim (28) of the growing tray (26) (Step 104), while the adjustable pre-harvest mat brackets (22) are fastened to the frame (14) of the pre-harvest mat (12) (Step 102). Steps 102 and 104 are interchangeable. The elevation setting and correlation indicators (24) on the riser clips (18) are used to set the pre-harvest mat (12) at a desired height above the growing tray (26), ensuring optimal airflow, microgreen density, and drainage beneath the mat (12). Seeds can then also be placed in the growing tray (26) if they haven't already been placed there beforehand, and the microgreens are allowed to grow up through the lattice (16) of the pre-harvest mat (12), which guides their vertical development, creates a confined density of microgreens, and prevents displacement of the mat (12) during the growth cycle (Step 106).

Steps are then taken for growing microgreens from the seeds placed in the growing tray (26). The growing and grown microgreens pass through the lattice (16) of the pre-harvest mat (12) (Step 106). Once the microgreens have reached maturity or their optimal state for harvesting, the riser clips (18) are removed (Step 108) by detaching the adjustable pre-harvest mat brackets (22) from the frame (14) of the pre-harvest mat (12) and the tray bracket (20) is removed from the rim (28) of the growing tray (26). The pre-harvest mat (12) is suspended above the rim (28) of the growing tray (26) in generally the same elevation as before the riser clips (18) are removed by the density of grown microgreens passing through lattice (16).

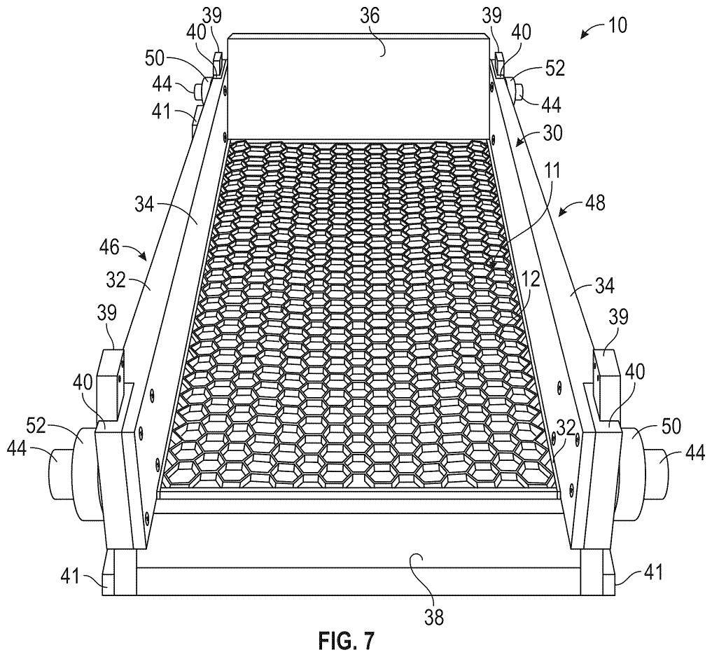

The grown microgreens in growing tray (26) passing through lattice (16) of the pre-harvest mat (12) are placed into the harvester (30) (Step 108). The base (32) of the harvester (30) receives the growing tray (26), with the back stop (36) preventing rearward movement and the front recess (38) allowing easy insertion and removal. The side guards (34) are adjusted to the desired height using rack-and-pinion mechanism (42) (Step 110), which corresponds with the height of the riser brackets (40) during growing of the microgreens. For example, the elevation setting and correlation indicators (54) on the riser brackets (40) are aligned with the indicators (24) on the riser clips (18) to ensure the side guards (34) are positioned at or nearly at the same elevation as the pre-harvest mat (12) (Step 112). Adjustment in the height of side guards (34) of left rack segment (46) and right rack segment (48) can be accomplished by (1) arresting the riser knob (50, 52) while rotating the locking mechanism (44) counterclockwise to unlock riser bracket (40), (2) rotating left riser knob (50) and right riser knob (52) in opposite directions to synchronize the height adjustments of the elevation setting and correlation indicators (24, 54) (Step 112), and (3) arresting the riser knob (50, 52) while rotating the locking mechanism (44) clockwise to lock the riser bracket (40) in place so the elevation setting and correlation indicators (24, 54) remain synced during harvesting the microgreens. When elevation setting and correlation indicators (24, 54) are synced as shown, for example, in FIG. 9, and the growing tray (26) is placed inside harvester (30) as shown, for example, in FIG. 7, the top side of the pre-harvest mat (12) is located just beneath the bottom side of the side guards (34), and with riser clips (18) removed, a harvesting mechanism, such as harvesting knife (56) can inserted into harvester (30) and while resting on pre-harvest mat (12) can be moved, in a cutting manner, from the front recess (38) toward the back stop (36) across the top surface of the pre-harvest mat (12) (Step 114). The stems of the microgreens are severed by the cutting action of the harvesting knife (56) and the stems of the microgreens being pushed up against the lattice (16) of the pre-harvest mat (12) and the side guards (34) in combination with the back stop (36) provide a barrier keeping cut microgreens from being displaced outside harvester (30) and resting atop the pre-harvest mat (12) where they can be easily handled, collected and redistributed for packaging (Step 116). After harvesting, the growing tray (26) can be removed via the front recess (38), and the growing tray (16), pre-harvest mat (12), and riser clips (18) can be cleaned and reused for growing another batch of microgreens.

In other aspects of the disclosure, the method (100) may include automated steps, such as using motorized riser knobs (50, 52) for height adjustment or integrating robotic cutting tools for high-volume production, further enhancing efficiency and reducing labor requirements. For example, the harvesting knife (56) can be incorporated into the pre-harvesting mat (12) whereby the harvesting knife (56) mirrors the shape of the pre-harvesting mat (12) its frame (14) and lattice (16) configuration except the edges of the lattice have a sufficient edge, that when the harvesting knife (56) is moved in a cutting action relative to the static pre-harvesting mat (12), the microgreens are cut for harvesting.

Although a microgreen growing and harvesting apparatus (10), a microgreen growing and harvesting system (10), and a method of growing and harvesting microgreens (100) is detailed, the disclosure regarding each is intended to supplement the disclosure of all. For example, any disclosure regarding the method of growing and harvesting microgreens (100) is intended to read on and supplement any disclosure regarding the microgreen growing and harvesting apparatus (10) and the microgreen growing and harvesting system (10) and vice-versa. For example, no disclosure regarding one is intended to be exclusive of any disclosure of the others.

The disclosure is not to be limited to the particular aspects described herein. In particular, the disclosure contemplates numerous variations in a microgreen growing and harvesting system (10), apparatus (10), and methods (100). The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions can be made, which are within the intended spirit and scope of the disclosure.

1. A microgreen grower and harvester apparatus comprising:
a pre-harvest mat having a frame housing a lattice with grid openings;
a set of riser clips;
a harvester having a base, a pair of side guards, a back stop, a front recess, and riser brackets operably connected to the side guards and the base, wherein the riser brackets include a rack-and-pinion mechanism for vertical adjustment of the pair of side guards relative to the base and the set of riser clips attached to the pre-harvest mat.

2. The apparatus of claim 1, wherein the lattice of the pre-harvest mat comprises a molded plastic grid with individual cells having a width configured for a microgreen plant to pass through while growing.

3. The apparatus of claim 1, wherein the riser clips and riser brackets include a set of elevation setting and correlation indicators for correlating alignment of the pre-harvest mat and the pair of side guards.

4. The apparatus of claim 1, wherein the riser brackets on opposing sides of the harvester rotate in opposite directions to synchronously elevate the pair of side guards.

5. The apparatus of claim 1, wherein the rack-and-pinion mechanism includes a locking mechanism to secure the pair of side guards at a desired height.

6. The apparatus of claim 1, wherein the front recess permits manual access to retrieve a growing tray with the attached set of riser clips and attached pre-harvest mat.

7. A microgreen harvesting system comprising:
a pre-harvest mat having a lattice configured to allow plant growth through lattice grid openings;
a growing tray configured for growing plants;
a set of riser clips configured for securing the pre-harvest mat to the growing tray at a desired elevation setting; and
a harvester having a base with side guards and riser brackets to support cutting of the grown plants at the desired elevation setting correlated between the set of riser clips and side guards of the harvester for retaining harvested plants within harvester for ease in packaging.

8. The system of claim 7, wherein the harvester base comprises a back stop and front recess.

9. The system of claim 7, wherein the riser clips and riser brackets include elevation setting and correlation indicators to correlate elevation between the two.

10. The system of claim 7, wherein the riser brackets include rack-and-pinion mechanisms.

11. The system of claim 7, wherein the side guards are attached to the riser brackets and adjustable in height.

12. The system of claim 7, wherein each riser bracket is correlated numerically with a corresponding riser clip.

13. A method of growing and harvesting microgreens comprising:
securing a pre-harvest mat to a growing tray with a set of riser clips;
growing microgreens in the growing tray through the pre-harvest mat;
placing the growing tray into a harvester; and
cutting the microgreens across the top of the pre-harvest mat and side guards of the harvester for supporting cutting and containing cut microgreens.

14. The method of claim 13, growing the microgreens in the growing pan up through a lattice of the pre-harvest mat.

15. The method of claim 13, further comprising:
securing a frame of the pre-harvest mat at a desired height above the growing tray with the riser clips.

16. The method of claim 13, further comprising:
adjusting a height of side guards using riser brackets with a rack-and-pinion system.

17. The method of claim 13, wherein the harvester includes a recess to facilitate growing tray insertion and removal post-harvest.

18. The method of claim 13, wherein the side guards are held in position at a desired height above a base of the harvester using locking mechanisms.

19. The method of claim 13, further comprising:
aligning riser clips and riser brackets at a desired height using numbered indicators.

20. The method of claim 13, wherein the pre-harvest mat and harvester support ergonomic and mess-free harvesting by securing the microgreens upright during cutting.
